(19) United States
(12) Patent Application Publication
(10) Pub. No.: US 2019/0078908 A1
(43) Pub. Date: Mar. 14, 2019

(54) RECORDING MEDIUM RECORDING INFORMATION OUTPUT PROGRAM, INFORMATION OUTPUT METHOD, AND INFORMATION PROCESSING APPARATUS

(71) Applicant: FUJITSU LIMITED, Kawasaki-shi (JP)

(72) Inventors: Xin Wang, Ota (JP); Masahiro Usui, Yokohama (JP); Hiroko Yuki, Yokohama (JP)

(73) Assignee: FUJITSU LIMITED, Kawasaki-shi (JP)

(21) Appl. No.: 16/190,892

(22) Filed: Nov. 14, 2018

Related U.S. Application Data
(63) Continuation of application No. PCT/JP2016/064498, filed on May 16, 2016.

(51) Int. Cl. G01C 21/36; G06Q 30/02; G01C 21/34

(52) U.S. Cl. CPC G01C 21/3697; G01C 21/3679; G06Q 30/0255; G06K 19/06037; G06Q 30/0261; G01C 21/3476; G06Q 30/0259

(57) ABSTRACT

A non-transitory computer-readable recording medium recording an information output program for causing a computer to execute a process, the process includes: detecting that a user performs first buying in a first shop; referring to memory in which shop information and location information are stored in association with each other; specifying one or more second shops that is in a predetermined positional relationship with route information which is a result of a search to a destination received from a user terminal used by the user and that is located closer to the destination than the first shop; generating a first message that includes information indicative of a payment detail as a result of the first buying and information introducing the one or more second shops; and outputting the first message as a receipt to a terminal provided in the first shop or transmitting the first message to the user terminal.

### CROSS-REFERENCE TO RELATED APPLICATION

This application is a continuation application of International Application PCT/JP2016/064498 filed on May 16, 2016 and designated the U.S., the entire contents of which are incorporated herein by reference.

### FIELD

The embodiments discussed herein are related to a recording medium recording an information output program, an information output method, and an information processing apparatus.

### BACKGROUND

There is a navigation device that receives route search including setting of a destination and displays a route search result.

A related technique is disclosed in Japanese Laid-open Patent Publication No. 2008-89342.

### SUMMARY

According to an aspect of the embodiments, a non-transitory computer-readable recording medium recording an information output program for causing a computer to execute a process, the process includes: detecting that a user performs first buying in a first shop or a first facility; referring to memory in which shop information or facility information and location information are stored in association with each other; specifying one or more second shops or one or more second facilities that is in a predetermined positional relationship with route information which is a result of a search to a destination received from a user terminal used by the user and that is located closer to the destination than the first shop or the first facility; generating a first message that includes information indicative of a payment detail as a result of the first buying and information introducing the one or more second shops or the one or more second facilities; and outputting the first message as a receipt to a terminal provided in the first shop or the first facility or transmitting the first message to the user terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schematic configuration of a system according to Example 1;

FIG. 2 is a diagram that illustrates an exemplary schematic configuration of an information output device according to Example 1;

FIG. 3 is a diagram that illustrates an exemplary data configuration of course information;

FIG. 4 is a diagram that illustrates an exemplary data configuration of member information;

FIG. 5 is a diagram that illustrates an exemplary data configuration of member shop information;

FIG. 6 is a diagram that illustrates an exemplary data configuration of weather information;

FIG. 7 is a diagram that illustrates an exemplary data configuration of weather-dependent recommended product information;

FIG. 8 is a diagram that illustrates an exemplary data configuration of purchase activity information;

FIG. 9 is a diagram that illustrates an exemplary data configuration of coupon information;

FIG. 10 is a diagram that illustrates an exemplary data configuration of coupon distribution information;

FIG. 11 is a diagram that illustrates an exemplary data configuration of payment information;

FIG. 12 is a diagram that illustrates an exemplary data configuration of sales information;

FIG. 13 is a diagram that illustrates an exemplary data configuration of promotion information;

FIG. 14 is a diagram that illustrates an exemplary data configuration of distance information;

FIG. 15 is a diagram that illustrates an exemplary receipt according to Example 1;

FIG. 16 is a diagram that illustrates an exemplary payment details notification screen according to Example 1;

FIG. 17 is a flowchart that illustrates an exemplary procedure of coupon distribution processing according to Example 1;

FIG. 18 is a diagram for describing matching according to Example 1;

FIG. 19 is a diagram that illustrates an exemplary receipt according to Example 2;

FIG. 20 is a diagram that illustrates an exemplary payment details notification screen according to Example 2;

FIG. 21 is a diagram that illustrates an exemplary receipt according to Example 2;

FIG. 22 is a diagram that illustrates an exemplary payment details notification screen according to Example 2;

FIG. 23 is a diagram that illustrates an exemplary data configuration of the member shop information including a group; and

FIG. 24 is a diagram that illustrates a computer that executes an information output program.

### DESCRIPTION OF EMBODIMENTS

For example, when displaying a route result, a navigation device displays not only a route but also shops, facilities, and the like on a map of an area including the route. For example, the navigation device receives setting of not only a destination but also a stop-by point and, therefore, displays a route search result to the destination by way of the stop-by point.

For example, if a user sets the stop-by point with the navigation device before departure, the user is able to reach the destination by way of the set stop-by point with no troubles in accordance with the displayed route. For example, the following arrangement is demanded in some cases. That is, a plurality of facilities or the like that would be candidates of the stop-by-points cooperate with one another to encourage the user to come to the facilities or the like for prosperity regardless of whether or not the facilities or the like are set as the stop-by-points.

For example, an arrangement that allows a plurality of shops to cooperate with one another so as to encourage the user to come to their shops may be provided.

Examples of an information output program, an information output method, and an information output system according to the embodiments are described below in detail with reference to the drawings. The embodiments are not limited by these Examples. It is possible to combine Examples appropriately as long as the processing details do not conflict. It is noted that, although merely the term “shop” is used in Examples below, this may refer to not only a shop in a narrow sense for selling products but also a facility for providing a service such as a movie theater or a spa.

### Example 1

### System Configuration

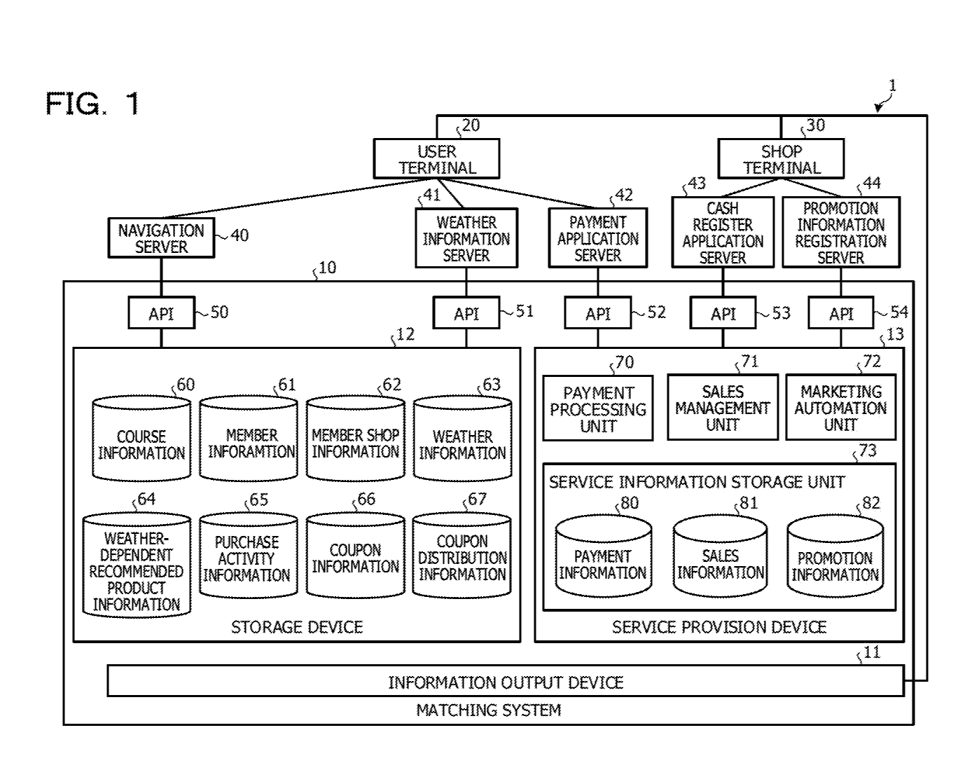

Next, an exemplary system 1 according to Example 1 is described. FIG. 1 is a diagram illustrating an example of a schematic configuration of a system according to Example 1. In this Example, an example in which the system 1 provides the user with information on a shop including privilege information (for example, coupons) is described, for example. It is noted that the shop may refer to not only a shop for selling products but also a facility for providing a service such as a movie theater or a spa.

As illustrated in FIG. 1, the system 1 has a matching system 10, a user terminal 20, a shop terminal 30, a navigation server 40, a weather information server 41, a payment application server 42, a cash register application server 43, and a promotion information registration server 44.

The matching system 10 is coupled to the user terminal 20, the shop terminal 30, the navigation server 40, the weather information server 41, the payment application server 42, the cash register application server 43, and the promotion information registration server 44. The user terminal 20 is coupled to the navigation server 40, the weather information server 41, and the payment application server 42. The shop terminal 30 is coupled to the cash register application server 43 and the promotion information registration server 44. Each server is a computer.

The navigation server 40 is a computer that has a function of providing a route search service in relation with navigation. The weather information server 41 is a computer that has a function of providing a weather information provision service. The payment application server 42 is a computer that has a function of providing a payment service. The cash register application server 43 is a computer that has a function of providing a sales management service. The promotion information registration server 44 is a computer that has a function of providing a promotion service.

The respective systems, terminals, and servers may be communicably coupled to one another via a network, for example. As one form of such a network, any type of communication networks such as a local area network (LAN) and a virtual private network (VPN) may be adopted regardless of wired or wireless. It is noted that, although the number of the provided user terminal 20 and the shop terminal 30 is one in the example of FIG. 1, it is not limited thereto. The number of the provided user terminal 20 and the shop terminal 30 may be set arbitrarily.

The matching system 10 provides the user with information and services that are generated based on the information acquired from the respective servers and the like. The matching system 10 may be implemented by a single computer or otherwise by a plurality of computers. It is noted that, in this Example, an example in which the matching system 10 is implemented by a plurality of computers is described.

The user terminal 20 is a device owned by the user who receives the information from the matching system 10. For example, the user terminal 20 is a mobile terminal device such as a car navigation system, a smartphone, or a tablet terminal. It is noted that the user terminal 20 may be a smartphone or a tablet terminal functioning as a car navigation system. The user terminal 20 otherwise may be a computer such as a laptop computer or a personal computer. The user receives services from each of the servers via an application provided in the user terminal 20.

Via the application, the user receives the route search service from the navigation server 40, for example. When the user receives the route search service, the user terminal 20 transmits to the navigation server 40 information for identifying the user, coordinates of a current location, information for specifying a destination input by the user, and the like, for example. The navigation server 40 then searches for the route from the current location to the destination and transmits to the user terminal 20 information or the like indicating the searched route, for example.

In addition, via the application, the user receives a weather information provision service from the weather information server 41, for example. When the user receives the weather information provision service, the user terminal 20 transmits to the weather information server 41 information for identifying the user, the coordinates of the current location, and the like, for example. The weather information server 41 then transmits to the user terminal 20 information on weather of the acquired current location, for example. It is noted that the information on the weather includes a category of weather such as sunny, cloudy, or rainy, humidity, temperature, and the like, for example.

Via the application, the user receives the payment service from the payment application server 42, for example. The payment service is, for example, to pay when the user buys a product or uses a service in an actual shop or an online shop on the Internet. When the user receives the payment service, the user terminal 20 transmits to the payment application server 42 information for identifying the user, information on the product the user buys, information on the shop the user used, information on a payment method such as a bank account or a credit card, and the like, for example. The payment application server 42 then performs payment using the acquired information, for example.

The shop terminal 30 is a terminal used in a shop. For example, the shop terminal 30 is a point of sale (POS) terminal provided in the shop, or a smartphone, a tablet terminal, a personal computer, or the like that has a POS functionality or an accounting functionality. The user of the shop terminal 30 receives services from each of the servers via an application provided in the shop terminal 30.

Via the application, the user of the shop terminal 30 receives the sales management service from the cash register application server 43, for example. When the shop receives the sales management service, the shop terminal 30 transmits to the cash register application server 43 information for identifying the shop, information for identifying a sold product, information on the price and the quantity of the sold product, information on the payment method, and the like, for example. The cash register application server 43 updates data on a stock of the product, sales, and the like varied by selling, for example.

In addition, via the application, the user of the shop terminal 30 receives a promotion service from the promotion information registration server 44, for example. When a shop receives the promotion service, the shop terminal 30 transmits to the promotion information registration server 44 information for identifying the shop, information on a promotion target product, a condition for setting a product as the promotion target, and the like, for example. The promotion information registration server 44 then provides a different system providing the promotion service with the information transmitted from the shop terminal 30, for example. In this Example, the promotion information registration server 44 provides the matching system 10 with the information, for example.

### Configuration of the Matching System 10

Next, a configuration of the matching system 10 according to Example 1 is described. As illustrated in FIG. 1, the matching system 10 has an information output device 11, a storage device 12, a service provision device 13, and application programming interfaces (APIs) 50 to 54.

The matching system 10 uses the APIs 50 to 54 to acquire data from the corresponding servers providing the services. For example, the matching system 10 uses the API 50 to acquire from the navigation server 40 information on the current location, the destination, and the route of a predetermined user. For example, the matching system 10 uses the API 51 to acquire from the weather information server 41 information on weather at a predetermined point.

For example, the matching system 10 uses the API 52 to acquire from the payment application server 42 information on payment of a predetermined user. For example, the matching system 10 uses the API 53 to acquire from the cash register application server 43 information on sales in a predetermined shop. For example, the matching system 10 uses the API 54 to acquire from the promotion information registration server 44 information on promotion in a predetermined shop.

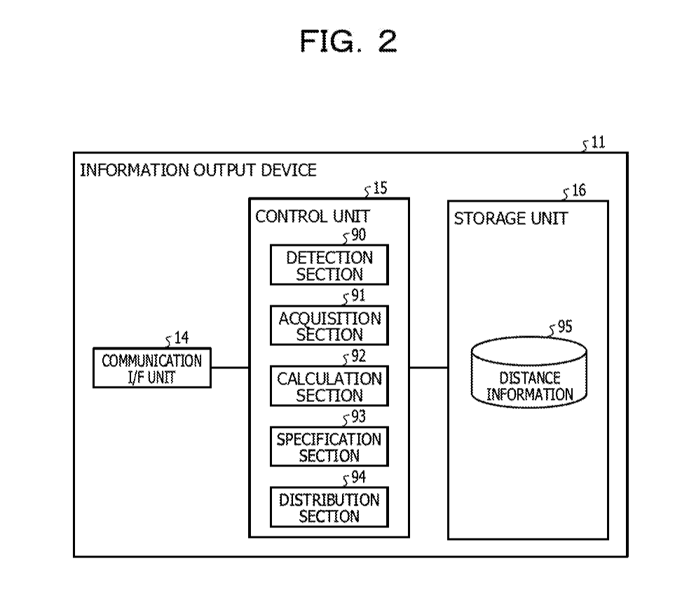

FIG. 2 is a diagram that illustrates a schematic configuration of the information output device. As illustrated in FIG. 2, the information output device 11 has a communication interface (I/F) unit 14, a control unit 15, and a storage unit 16.

The communication I/F unit 14 is an interface that controls communication with other devices. The communication I/F unit 14 transmits and receives various types of information to and from the other devices via a network. A network interface card such as a LAN card may be employed as the communication I/F unit 14. The control unit 15 has a detection section 90, an acquisition section 91, a calculation section 92, a specification section 93, and a distribution section 94. The storage unit 16 and operations of the sections of the control unit 15 are described later. The distribution section 94 is an exemplary output section.

The storage device 12 is a storage device such as a hard disk, a solid-state drive (SSD), or an optical disk. It is noted that the storage device 12 may be a data-rewritable semiconductor memory such as a random access memory (RAM), a flash memory, or a non-volatile static random access memory (NVSRAM). The storage device 12 may be a server device that stores and provides data.

The storage device 12 stores various programs. For example, the storage device 12 stores a program that executes later-described coupon distribution processing. In addition, the storage device 12 stores various types of data used for those programs. For example, the storage device 12 stores course information 60, member information 61, member shop information 62, weather information 63, weather-dependent recommended product information 64, purchase activity information 65, coupon information 66, and coupon distribution information 67.

The course information 60 is data that stores information on a location and a route of the user. For example, the course information 60 stores information on the current location, the destination, and the route of the user. In addition, the course information 60 stores route search conditions set via the user terminal 20 or a route search result of searching with the route search conditions set via the user terminal 20. The search conditions are, for example, coordinates that indicate the current location, a stop-by point, the destination, and the like. The search result is data indicating a route from the current location to the destination.

It is noted that the information may be stored in the course information 60 by causing the API 50 to regularly acquire the data from the navigation server 40. In addition, the information may be stored in the course information 60 by causing the navigation server 40 to notify the matching system 10 of the route search result when the navigation server 40 provides the user with the route search service.

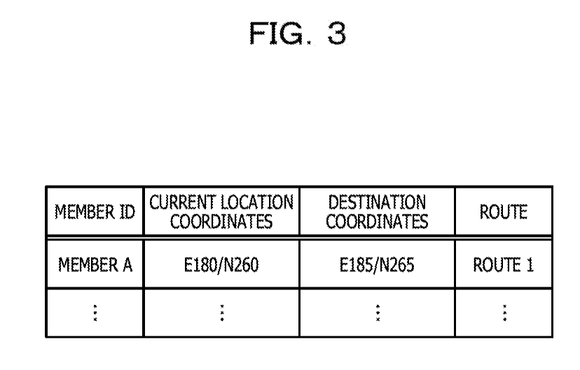

FIG. 3 is a diagram that illustrates an exemplary data configuration of the course information. As illustrated in FIG. 3, the course information 60 has items such as “member ID”, “current location coordinates”, “destination coordinates”, and “route”. It is noted that each of the items of the course information 60 illustrated in FIG. 3 is examples, and an item or items other than these may be provided.

The item of the member ID is a region that stores an ID for identifying the user. The item of the member ID stores the member ID of the user on a user-by-user basis set in advance. The item of the current location coordinates is a region that stores the coordinates of the current location of the user. The item of the destination coordinates is a region that stores the coordinates of the destination of the user. The item of the route is a region that stores the route from the current location to the destination. The item of the route stores data that indicates the route from the current location to the destination of the user of which the member ID is stored in the item of the member ID. It is noted that the data stored in the course information 60 is, for example, the data acquired from the navigation server 40 by the API 50.

Referring back to FIG. 1, the member information 61 is data that stores information on attributes of the user. For example, the member information 61 stores information on the attributes such as gender and age of the user.

It is noted that the information may be registered in advance in the member information 61 by an administrator or the like before the matching system 10 provides the service. The member information 61 may store the information that the user inputs to the application of the user terminal 20 and the like at a timing at which the user registers for the membership and the like to receive the information and the service from the matching system 10. The information stored in the member information 61 may be updated based on information regularly collected from the user terminal 20 and the like.

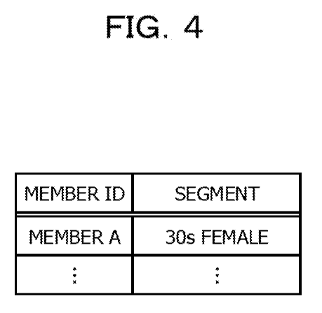

FIG. 4 is a diagram that illustrates an exemplary data configuration of the member information. As illustrated in FIG. 4, the member information 61 has items such as “member ID” and “segment”. It is noted that each of these items of the member information 61 illustrated in FIG. 4 is examples, and an item or items other than these may be provided.

The item of the member ID is a region that stores an ID for identifying the user. The item of the segment is a region that stores a category based on the attributes of the user. The item of the segment stores a segment categorized in terms of gender and age of the user of which the member ID is stored in the item of the member ID.

Referring back to FIG. 1, the member shop information 62 is data that stores the information on the member shop. For example, the member shop information 62 stores information on a location of the member shop and target customer types. It is noted that, in the following description, the member shop is synonymous with the shop or the facility.

It is noted that the information may be registered in advance in the member shop information 62 by the administrator or the like before the matching system 10 provides the service. The information stored in the member shop information 62 may be updated based on information regularly collected from the shop terminal 30 and the like.

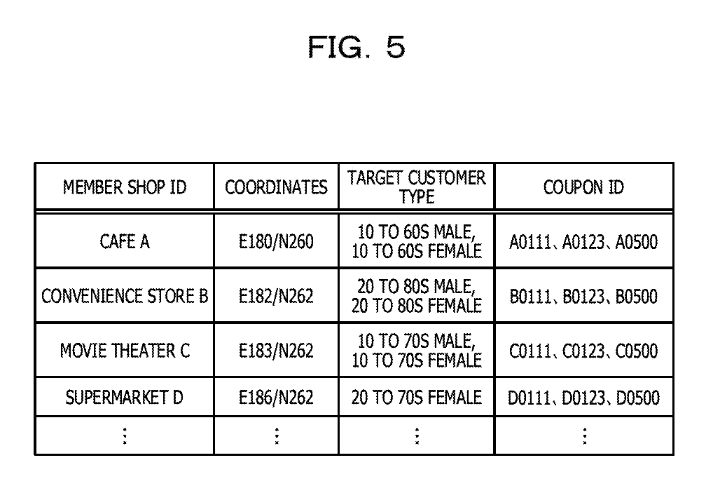

FIG. 5 is a diagram that illustrates an exemplary data configuration of the member shop information. As illustrated in FIG. 5, the member shop information 62 has items such as “member shop ID”, “coordinates”, “target customer type”, and “coupon ID”. It is noted that each of these items of the member shop information 62 illustrated in FIG. 5 is examples, and an item or items other than these may be provided.

The item of the member shop ID is a region that stores an ID for identifying the member shop. The item of the member shop ID stores a member shop ID of the member shop on a member shop-by-member shop basis set in advance. The item of the coordinates is a region that stores coordinates of the location of the member shop. The item of the target customer type is a region that stores the customer types as targets of the member shop. The item of the target customer type stores segments of customers as the targets of the member shop of which the member shop ID is stored in the item of the member shop ID. It is noted that each of the segments to be stored in the item of the target customer type corresponds to the segment of the member information 61. The item of the coupon ID is a region that stores IDs of coupons usable in the member shop. The item of the coupon ID stores the IDs of the coupons usable in the member shop of which the member shop ID is stored in the item of the member shop ID.

Referring back to FIG. 1, the weather information 63 is data that stores information on weather. For example, the weather information 63 stores information on weather of a predetermined location.

It is noted that the information may be stored in the weather information 63 by causing the API 51 to regularly acquire the data from the weather information server 41. The information may be stored in the weather information 63 by causing the API 51 to acquire the data from the weather information server 41 at a timing at which the user receives the route search service.

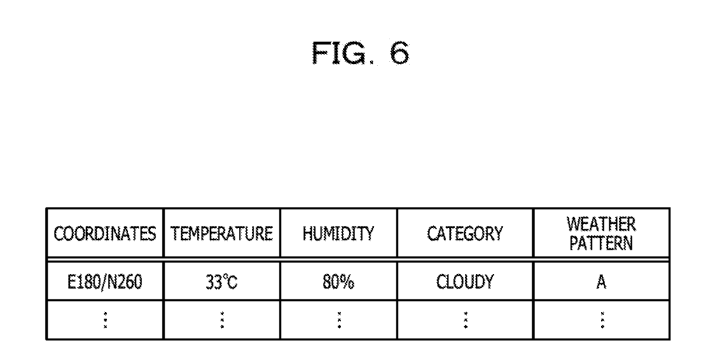

FIG. 6 is a diagram that illustrates an exemplary data configuration of the weather information. As illustrated in FIG. 6, the weather information 63 has items such as “coordinates”, “temperature”, “humidity”, “category”, and “weather pattern”. It is noted that each of these items of the weather information 63 illustrated in FIG. 6 is examples, and an item or items other than these may be provided.

The item of the coordinates is a region that stores coordinates of a predetermined location. The item of the temperature, the item of the humidity, and the item of the category are regions that store temperature, humidity, and a category of weather, respectively. The item of the temperature, the item of the humidity, and the item of the category store the temperature, the humidity, and the category of weather at the coordinates stored in the item of the coordinates, respectively. The item of the weather pattern is a region that stores a pattern of weather. The item of the weather pattern stores a value that indicates the pattern of weather categorized based on the temperature, the humidity, the category of weather, and the like. It is noted that the temperature, the humidity, and the category of weather are, for example, the data acquired from the weather information server 41 by the API 51. The weather pattern may be a value calculated by the matching system 10 based on the acquired temperature, humidity, and the category of weather, and a determination criterion set in advance.

Referring back to FIG. 1, the weather-dependent recommended product information 64 is data that stores information on a product that is recommended to be sold according to weather for the member shop. For example, the weather-dependent recommended product information 64 stores a recommended product according to the weather pattern on a member shop-by-member shop basis.

It is noted that the information may be registered in advance in the weather-dependent recommended product information 64 by the administrator or the like before the matching system 10 provides the service. The information stored in the weather-dependent recommended product information 64 may be updated based on the information regularly collected from the shop terminal 30 and the like.

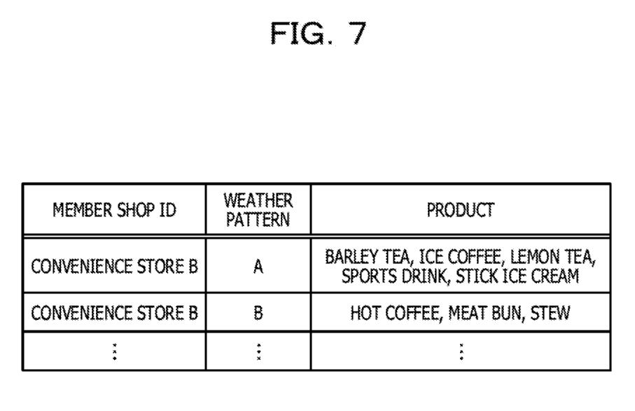

FIG. 7 is a diagram that illustrates an exemplary data configuration of the weather-dependent recommended product information. As illustrated in FIG. 7, the weather-dependent recommended product information 64 has items such as “member shop ID”, “weather pattern”, and “product”. It is noted that each of these items of the weather-dependent recommended product information 64 illustrated in FIG. 7 is examples, and an item or items other than these may be provided.

The item of the member shop ID is a region that stores an ID for identifying the member shop. The item of the weather pattern is a region that stores the weather pattern categorizing weather. The item of the product is a region that stores recommended products according to the weather pattern. The item of the product stores the recommended products according to the weather pattern stored in the item of the weather pattern of the member shop of which the member shop ID is stored in the item of the member shop ID.

Referring back to FIG. 1, the purchase activity information 65 is data that stores information on a purchase activity of the user. For example, the purchase activity information 65 stores a category of a product of which purchase frequency by the user is high in each type of the shops.

It is noted that the information may be registered in advance in the purchase activity information 65 by the administrator or the like before the matching system 10 provides the service. The information stored in the purchase activity information 65 may be updated based on the information regularly collected from the payment information 80 and the like.

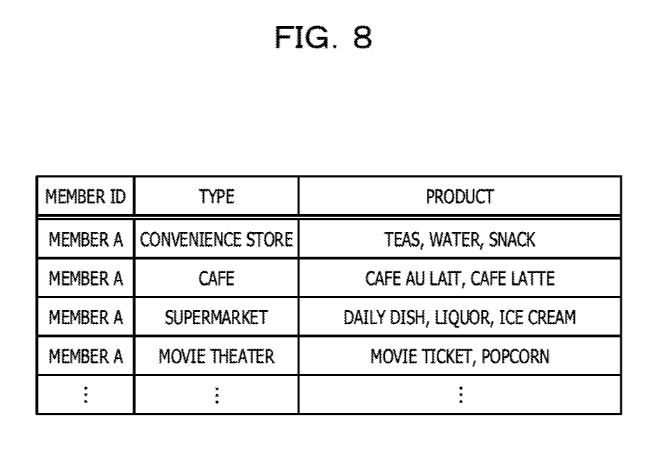

FIG. 8 is a diagram that illustrates an exemplary data configuration of the purchase activity information. As illustrated in FIG. 8, the purchase activity information 65 has items such as “member ID”, “type”, and “product”. It is noted that each of these items of the purchase activity information 65 illustrated in FIG. 8 is examples, and an item or items other than these may be provided.

The item of the member ID is a region that stores an ID for identifying the user. The item of the type is a region that stores one of categorized types of member shops. The item of the product is a region that stores the products of which purchase frequency by the user is high for a type of the member shops. The item of the product stores products of which purchase frequency by the user whose member ID is stored in the item of the member ID is high for the type of the member shops which is stored in the type.

Referring back to FIG. 1, the coupon information 66 is data that stores information on a coupon. For example, the coupon information 66 stores the information on the coupon content.

It is noted that the information may be registered in advance in the coupon information 66 by the administrator or the like before the matching system 10 provides the service. The information stored in the coupon information 66 may be updated based on the information regularly collected from the shop terminal 30 and the like.

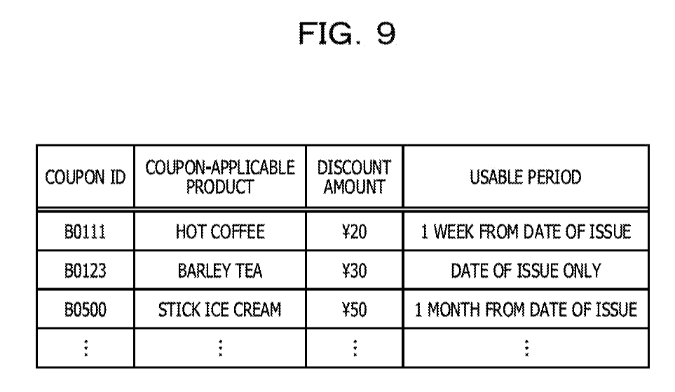

FIG. 9 is a diagram that illustrates an exemplary data configuration of the coupon information. As illustrated in FIG. 9, the coupon information 66 has items such as “coupon ID”, “coupon-applicable product”, “discount amount”, and “usable period”. It is noted that each of these items of the coupon information 66 illustrated in FIG. 9 is examples, and an item or items other than these may be provided.

The item of the coupon ID is a region that stores an ID for identifying a coupon. The item of the coupon ID stores an ID that is set when issuing the coupon. The item of the coupon-applicable product is a region that stores a product for which the coupon is usable. The item of the discount amount is a region that stores a discount amount using the coupon. The item of the usable period is a region that stores a period in which the coupon is usable.

Referring back to FIG. 1, the coupon distribution information 67 is data that stores information on the distributed coupon. For example, the coupon distribution information 67 stores information on the user to which the coupon is distributed and a status of use of the coupon.

It is noted that information on the coupon may be registered in the coupon distribution information 67 at a timing at which the user decides the coupon distributed through the coupon distribution processing. The information stored in the coupon distribution information 67 may be appropriately updated at a timing at which the user uses the coupon, for example.

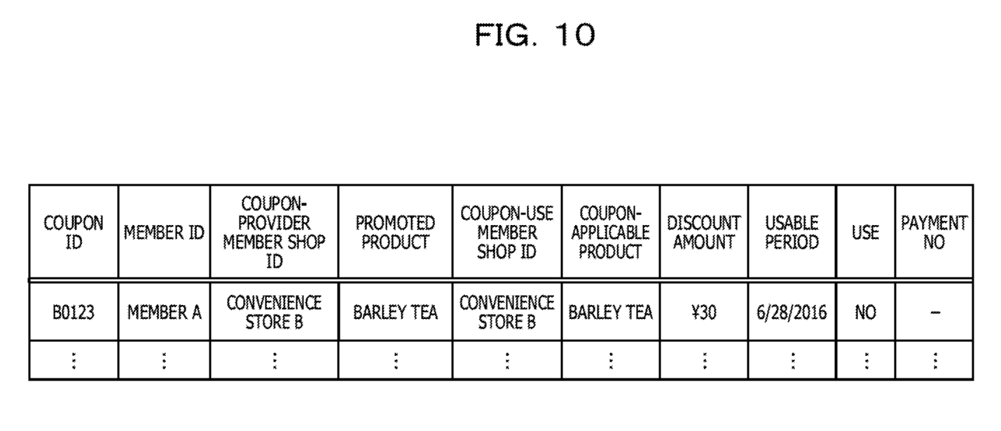

FIG. 10 is a diagram that illustrates an exemplary data configuration of the coupon distribution information. As illustrated in FIG. 10, the coupon distribution information 67 has items such as “coupon ID”, “member ID”, “coupon-provider member shop ID”, “promoted product”, “coupon-use member shop ID”, “coupon-applicable product”, “discount amount”, “usable period”, “use”, and “payment No”. It is noted that each of these items of the coupon distribution information 67 illustrated in FIG. 10 is examples, and an item or items other than these may be provided.

The item of the coupon ID is a region that stores an ID for identifying a coupon. The item of the coupon ID stores the ID that is set when issuing the coupon. The item of the member ID is a region that stores an ID for identifying the user. The item of the coupon-provider member shop ID is a region that stores an ID for identifying a member shop that provides the coupon. The item of the promoted product is a region that stores the product as the promotion target in the member shop that provides the coupon. The item of the coupon-use member shop ID is a region that stores an ID for identifying a member shop for which the coupon is usable. The item of the coupon-applicable product is a region that stores a product to which the coupon is usable. The item of the discount amount is a region that stores a discount amount using the coupon. The item of the usable period is the region that stores the period in which the coupon is usable. The item of the use is a region that stores whether the coupon has already been used. The payment No is a region that stores a number for identifying the payment using the coupon.

Referring back to FIG. 1, the service provision device 13 has a payment processing unit 70, a sales management unit 71, a marketing automation unit 72, and a service information storage unit 73. The service information storage unit 73 stores the payment information 80, sales information 81, and promotion information 82.

The payment processing unit 70 stores into the payment information 80 the information on payment of the user acquired through the API 52. The sales management unit 71 stores into the sales information 81 the information on sales in the shop acquired through the API 53.

The marketing automation unit 72 acquires the information on the promotion in the shop acquired through the API 54, determines whether the shop is the promotion target, and stores into the promotion information 82 the information on the promotion with the determination result.

The payment information 80 is data that stores the information on payment of the user. For example, the payment information 80 stores information on the member shop where the user purchased a product, a price of the purchased product, and the like.

It is noted that the information may be stored in the payment information 80 by causing the API 52 to regularly acquire the data from the payment application server 42. The information may be stored in the payment information 80 by causing the payment application server 42 to notify the matching system 10 of the information on payment when the payment application server 42 provides the member shop with the payment processing service.

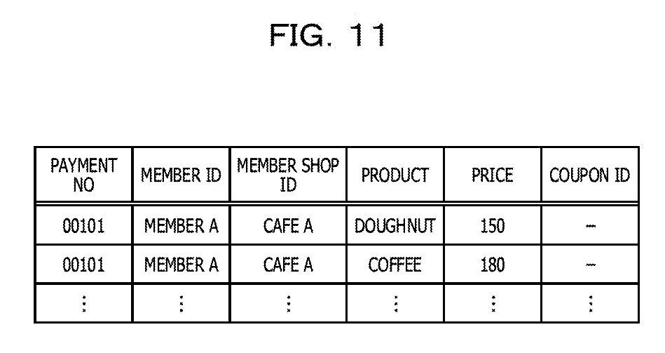

FIG. 11 is a diagram that illustrates an exemplary data configuration of the payment information. As illustrated in FIG. 11, the payment information 80 has items such as “payment No”, “member ID”, “member shop ID”, “product”, “price”, and “coupon ID”. It is noted that each of these items of the payment information 80 illustrated in FIG. 11 is examples, and an item or items other than these may be provided.

The item of the payment No is a region that stores a number for identifying the payment. The item of the payment No stores a serial number issued when the payment is made. The item of the member ID is a region that stores an ID for identifying the user. The item of the member shop ID is a region that stores an ID for identifying the member shop. The item of the product is a region that stores a product as the payment target. The item of the price is a region that stores the payment amount. The item of the coupon ID is a region that stores an ID for identifying the coupon used in the payment. It is noted that the data stored in the payment information 80 is, for example, the data acquired from the payment application server 42 by the API 52.

Referring back to FIG. 1, the sales information 81 is the data that stores the information on sales in the member shop. For example, the sales information 81 stores a price or the like of the product of which the payment is made in the member shop.

It is noted that the information may be stored in the sales information 81 by causing the API 53 to regularly acquire the data from the cash register application server 43. The information may be stored in the sales information 81 by causing the cash register application server 43 to notify the matching system 10 of the information on sales when the cash register application server 43 provides the member shop with the sales management service.

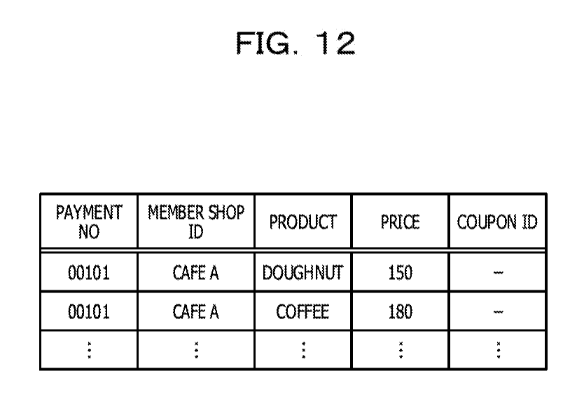

FIG. 12 is a diagram that illustrates an exemplary data configuration of the sales information. As illustrated in FIG. 12, the sales information 81 has items such as “payment No”, “member shop ID”, “product”, “price”, and “coupon ID”. It is noted that each of these items of the sales information 81 illustrated in FIG. 12 is examples, and an item or items other than these may be provided.

The item of the payment No is a region that stores a number for identifying the payment. The item of the member shop ID is a region that stores an ID for identifying the member shop. The item of the product is a region that stores a product as the payment target. The item of the price is a region that stores the payment amount. The item of the coupon ID is a region that stores an ID for identifying the coupon used in the payment. It is noted that the data stored in the sales information 81 is, for example, the data acquired from the cash register application server 43 by the API 53.

Referring back to FIG. 1, the promotion information 82 is data that stores information on promotion in the member shop. For example, the promotion information 82 stores the product or the like as the promotion target in the member shop.

It is noted that the information may be stored in the promotion information 82 by causing the API 54 to regularly acquire the data from the promotion information registration server 44. The information may be stored in the promotion information 82 by causing the promotion information registration server 44 to notify the matching system 10 of the information on the promotion when this information is registered in the promotion information registration server 44.

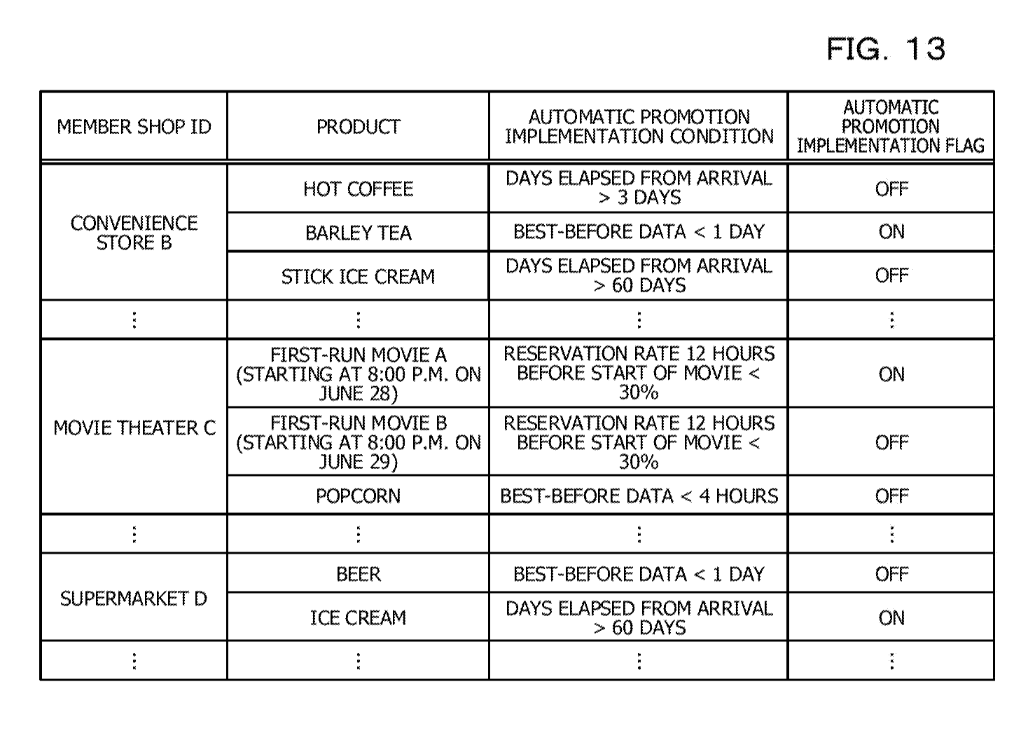

FIG. 13 is a diagram that illustrates an exemplary data configuration of the promotion information. As illustrated in FIG. 13, the promotion information 82 has items such as “member shop ID”, “product”, “automatic promotion implementation condition”, and “automatic promotion implementation flag”. It is noted that each of these items of the promotion information 82 illustrated in FIG. 13 is examples, and an item or items other than these may be provided.

The item of the member shop ID is a region that stores an ID for identifying the member shop. The item of the product is the region that stores the product as the promotion target. The item of the automatic promotion implementation condition is a region that stores a condition for turning ON an automatic promotion implementation flag. The item of the automatic promotion implementation flag is a region that stores a flag that is turned ON when the automatic promotion implementation condition is satisfied. Note that the data stored in the promotion information 82 is, for example, the data acquired from the promotion information registration server 44 by the API 54.

### Coupon Distribution Processing

Here, an operation of each of the sections of the information output device 11 and the coupon distribution processing are described. Upon detecting a buying activity of the user, the information output device 11 provides the user with information introducing another member shop near a route to the destination. According to this Example, the information output device 11 provides privilege information as information on the other member shop, for example, the coupon. The information output device 11 is an exemplary information output system.

A detection section 90 of the information output device 11 illustrated in FIG. 2 detects that the buying activity in a first shop or a first facility is performed by the user. The acquisition section 91 acquires information from a storage device 12 that stores the shop information or facility information and location information such that the shop information or the facility information is associated with the location information. The storage device 12 is an exemplary storage unit.

The specification section 93 refers to the information obtained by the acquisition section 91, the information being information in which the shop information or the facility information is associated with the location information. The specification section 93 specifies second shops or second facilities. The second shops or the second facilities are each in a predetermined positional relationship with route information which is a search result to the destination for which the setting has been received from the user terminal used by the user. Also, the second shops or the second facilities are located closer to the destination than the first shop or the first facility. At this time, the calculation section 92 calculates the distance between each of the shops or facilities and the destination.

The distribution section 94 causes a terminal provided in the first shop or the first facility to output a receipt including information on the payment details as a result of the buying activity and information for introducing the second shop or the second facility. The distribution section 94 may generate a message including the information on the payment details as a result of the buying activity in the first shop or the first facility and information introducing the second shop or the second facility and transmit the generated message to the user terminal 20.

For example, the detection section 90 regularly refers to the payment information 80 or the sales information 81 associated with the first shop or the first facility and detects that the user has performed the buying activity in the first shop or the first facility when a record has been added to the information. Alternatively, for example, the detection section 90 may detect that the user has performed the buying activity when a notification that the payment has been performed is received from a computer having a payment processing function provided in the first shop or the first facility.

An application program in the user terminal 20 may have a function of notifying the matching system 10 of the fact that the user has performed payment by using the payment service. In this case, the detection section 90 is able to detect the buying activity of the user when the notification is performed by the above-described function.

When the buying activity of the user is detected by the detection section 90, first, the acquisition section 91 refers to the course information 60 and acquires route information, for example, the current location coordinates, the destination coordinates, and the route of the user. Next, the acquisition section 91 refers to the member shop information 62 and acquires member shops around the acquired route. The acquisition section 91 then refers to the member information 61 and the member shop information 62 and checks whether there are member shops having the target customer type that matches the segment of the user.

Here, when there are member shops having the target customer type matching the segment of the user, the calculation section 92 calculates the distance between each of these member shops and the destination and stores resulting distances in the storage unit 16 as the distance information 95. At this time, since the member shops for which calculation is performed by the calculation section 92 are narrowed down to the member shops around the route, the distances calculated by the calculation section 92 are not for all the member shops. Accordingly, the amount of the calculation performed by the calculation section 92 may be reduced.

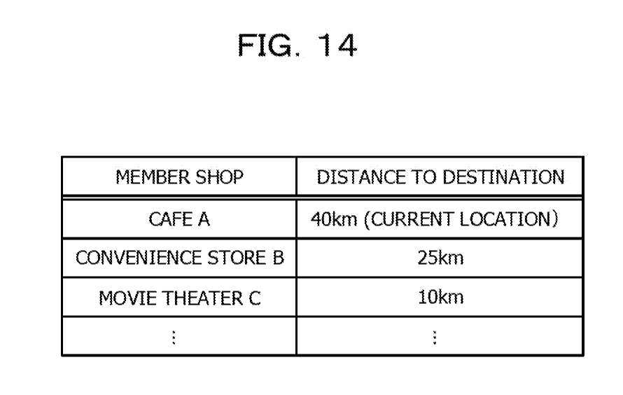

The distance information 95 is data that stores the distance between each member shop and the destination. For example, the distance to each member shop or the destination or the like is stored in the distance information 95. FIG. 14 is a diagram that illustrates an exemplary data configuration of the distance information. As illustrated in FIG. 14, the distance information 95 has items such as “member shop” and “distance to destination”. It is noted that each of the items of the distance information 95 illustrated in FIG. 14 is examples, and an item or items other than these may be provided.

Alternatively, for example, as the distances to the destination, instead of values representing the distances themselves to the destination, information that is able to specify member shops located closer to the destination than a certain member shop may be stored. For example, information indicating the order of arrival of the user moving along the route to the destination in the member shops may be stored. Regarding the example illustrated in FIG. 14, when “cafe A”, “convenience store B”, and “movie theater C” are numbered for indicating the order from farthest to closest to the destination, the cafe A is “1”, the convenience store B is “2”, and the movie theater C is “3”.

The item of the member shop is a region that stores information for identifying the member shop. The item of the member shop stores the name of the member shop or the ID or the like for identification. The item of the distance to destination is a region that stores the distance from the member shop to the destination. The item of the distance to destination stores the distance calculated by the calculation section 92.

Next, the acquisition section 91 refers to the weather information 63 and acquires the weather pattern at the current location of the user. The acquisition section 91 then refers to the weather-dependent recommended product information 64 and, according to the acquired weather pattern, acquires recommended products of the member shops having the target customer type that matches the segment of the user. The acquisition section 91 then refers to the purchase activity information 65 and acquires products of which purchase frequency by the user is high in each type of the member shops.

At this point, based on the acquired recommended products and the products of which purchase frequency by the user is high, the acquisition section 91 narrows the products to the coupon-applicable target. The acquisition section 91 then refers to the promotion information 82 and checks whether there is a member shop as the promotion target, for example, a member shop holding a product for which the automatic promotion implementation flag is ON.

When there is a member shop as the promotion target, the specification section 93 specifies a coupon to be distributed. For example, out of the member shops having the target customer type that matches the segment of the user, the specification section 93 specifies, as the coupon-provider member shop, the member shop located around the route and closer to the destination than the other member shop in which the buying activity of the user has been detected. Meanwhile, out of the member shops having the target customer type that matches the segment of the user, the specification section 93 specifies, as the coupon-use member shop, the member shop located around the route and closer to the destination than the other member shop in which the buying activity of the user has been detected and specifies, as the coupon-applicable target product, the product narrowed to the coupon-applicable target by the acquisition section 91. Furthermore, the specification section 93 refers to the member shop information 62 and the coupon information 66 and specifies a coupon corresponding to the coupon-use member shop and the coupon-applicable target product. The coupon-provider member shop and the coupon-use member shop may be the same. The specification section 93 determines whether the member shop is closer to the destination than the other member shop in which the buying activity of the user has been detected based on the distance information 95.

It is noted that the specification section 93 may specify a plurality of coupon-provider member shops, coupon-use member shops, and coupon-applicable target products. Furthermore, in this case, a plurality of types of coupons may be distributed to the user.

The distribution section 94 distributes to the user terminal 20 the coupon specified by the specification section 93 combined with the information on the specified coupon-provider member shop and the promotion of the promoted product. When the user decides a desired coupon out of the distributed coupons, the information on that coupon decided by the user is registered in the coupon distribution information 67. It is noted that the matching system 10 may be notified that the user has decided the coupon by, for example, the user terminal 20 via the application.

Here, the coupon distribution processing is described with an example. First, upon detection of the buying activity of the user “member A” by the detection section 90, the acquisition section 91 refers to the course information 60 and acquires the current location coordinates “E180/N260”, the destination coordinates “E185/N265”, and the route “route 1” of the user “member A”. Next, the acquisition section 91 refers to the member shop information 62 and acquires the member shops around the route “cafe A”, “convenience store B”, “movie theater C”, and “supermarket D”. The acquisition section 91 then refers to the member information 61 and the member shop information 62 and checks whether there are member shops having the target customer type that matches the segment “30s female” of the user “member A”. In this case, the member shops “cafe A”, “convenience store B”, “movie theater C”, and “supermarket D” match the segment “30s female”. The calculation section 92 calculates the distances from the member shops “cafe A”, “convenience store B”, “movie theater C”, and “supermarket D” to the destination and stores the resulting distances in the storage unit 16 as the distance information 95.

The acquisition section 91 refers to the weather information 63 and acquires the weather pattern “A” at the current location “E180/N260” of the user “member A”. The acquisition section 91 then refers to the weather-dependent recommended product information 64 and acquires the recommended products “barley tea, ice coffee, lemon tea, sports drink, stick ice cream” of the member shop “convenience store B” for the weather pattern “A”. The acquisition section 91 then refers to the purchase activity information 65 and acquires the products “teas, water, snack” of which purchase frequency by the user “member A” is high in the type “convenience store”. Likewise, also for the member shops “cafe A”, “movie theater C”, and “supermarket D”, the acquisition section 91 acquires the recommended products for the weather pattern “A” and the products of which purchase frequency by the “member A” is high in the member shop types.

Based on the acquired recommended products “barley tea, ice coffee, lemon tea, sports drink, stick ice cream” and the products of which purchase frequency by the user is high, “teas, water, snack”, the acquisition section 91 narrows the products to “barley tea, lemon tea” as the coupon-applicable target. The acquisition section 91 then refers to the promotion information 82 and checks whether there is a member shop holding a product for which the automatic promotion implementation flag is ON. In this case, the automatic promotion implementation flag of “barley tea” of the member shop “convenience store B” is ON. Likewise, also for the member shops “cafe A”, “movie theater C”, and “supermarket D”, the acquisition section 91 narrows the products to the coupon-applicable targets and checks whether there are products for which the automatic promotion implementation flags are ON. At this time, it is assumed that, for the member shops “convenience store B”, “movie theater C”, and “supermarket D”, the acquisition section 91 narrows the products to the coupon-applicable targets and confirms that there are products for which the automatic promotion implementation flags are ON.

As the coupon-provider member shop and the coupon-use member shop, the specification section 93 specifies “convenience store B” and “movie theater C” that are around the route and closer to the destination than “cafe A” being the member shop in which the buying activity of the user “member A” has been detected by the detection section 90. Since “cafe A” does not satisfy the condition of “closer to the destination than “cafe A””, the specification section 93 does not specify “cafe A”. Since “supermarket D” is not located around the route, the specification section 93 does not specify “supermarket D”.

Furthermore, the specification section 93 specifies the coupon-use member shop that is closest to the destination in distance. For example, the specification section 93 specifies “convenience store B” as the coupon-use member shop closest to the destination in distance. Furthermore, the specification section 93 refers to the member shop information 62 and the coupon information 66 and specifies “B0123” as the coupon corresponding to the coupon-use member shop and the coupon-applicable product.

The distribution section 94 causes the terminal provided in the member shop in which the buying activity of the user detected by the detection section 90 is performed to output a receipt including the information on the payment details as a result of the buying activity and the coupon “B0123” specified by the specification section 93. The distribution section 94 may generate a message including the information indicating the payment details as a result of the buying activity in the member shop in which the buying activity of the user detected by the detection section 90 is performed and the coupon “B0123” and transmit the generated message to the user terminal 20.

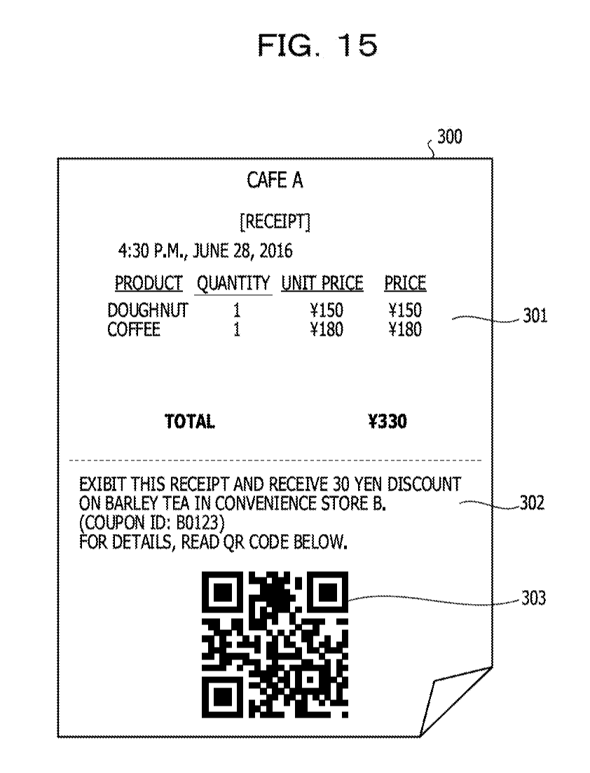

FIG. 15 is a diagram that illustrates an exemplary receipt according to Example 1. As illustrated in FIG. 15, a receipt 300 issued by the shop terminal 30 has a sales information presenting region 301 that presents information on the name, the quantity, the unit price, and the price of the sold product, the information being exemplary information indicative of the payment details as a result of the purchase activity. The receipt 300 also has a promotion region 302 that is a region presenting the information introducing the second shop or the second facility. The receipt 300 further has a link presenting region 303 that presents a QR code (registered trademark) indicative of a uniform resource locator (URL) of a website on which details of the second shop or the second facility are published.

In the example of FIG. 15, as the payment details, the receipt 300 indicates that, in “cafe A”, one doughnut the unit price of which is 150 yen and a cup of coffee the unit price of which is 180 yen were bought, and the total price was 330 yen. As the information introducing the second shop or the second facility, the receipt 300 further presents discount information on “convenience store B” with the QR code.

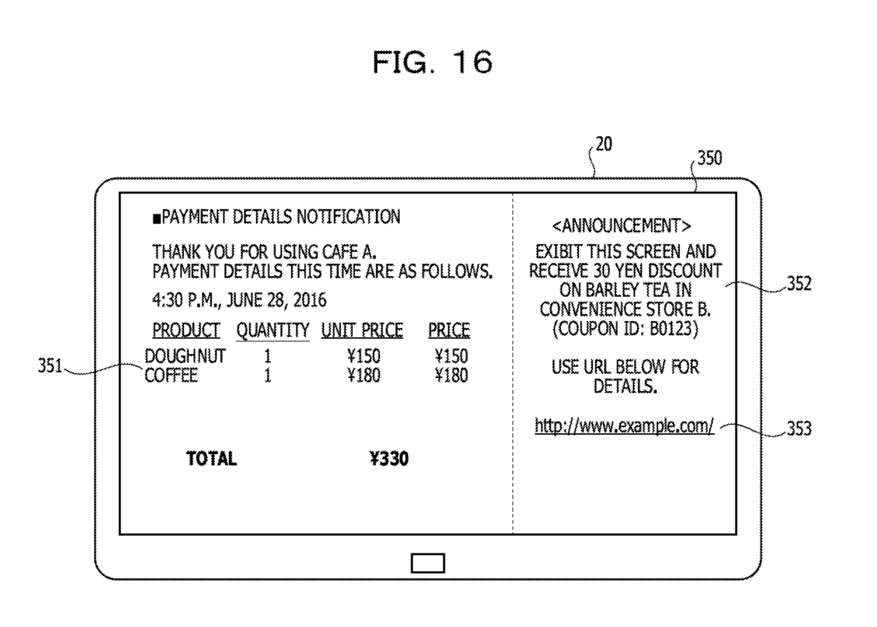

FIG. 16 is a diagram that illustrates an exemplary payment details notification screen according to Example 1. As illustrated in FIG. 16, a payment details notification screen 350 displayed in the user terminal 20 has a payment information display region 351 that displays information on the name, the quantity, the unit price, and the price of the paid product, the information being exemplary information indicative of payment details in the first shop. The payment details notification screen 350 also has a promotion region 352 that is a region for displaying the information introducing the second shop or the second facility and a link display region 353 that displays the URL of the website on which details of the second shop or the second facility are published.

In the example of FIG. 16, as the payment details, the payment details notification screen 350 indicates that, in “cafe A”, one doughnut the unit price of which is 150 yen and a cup of coffee the unit price of which is 180 yen were bought, and the total price was 330 yen. As the information introducing the second shop or the second facility, the payment details notification screen 350 further displays discount information on “convenience store B” with the URL.

### Process Flow

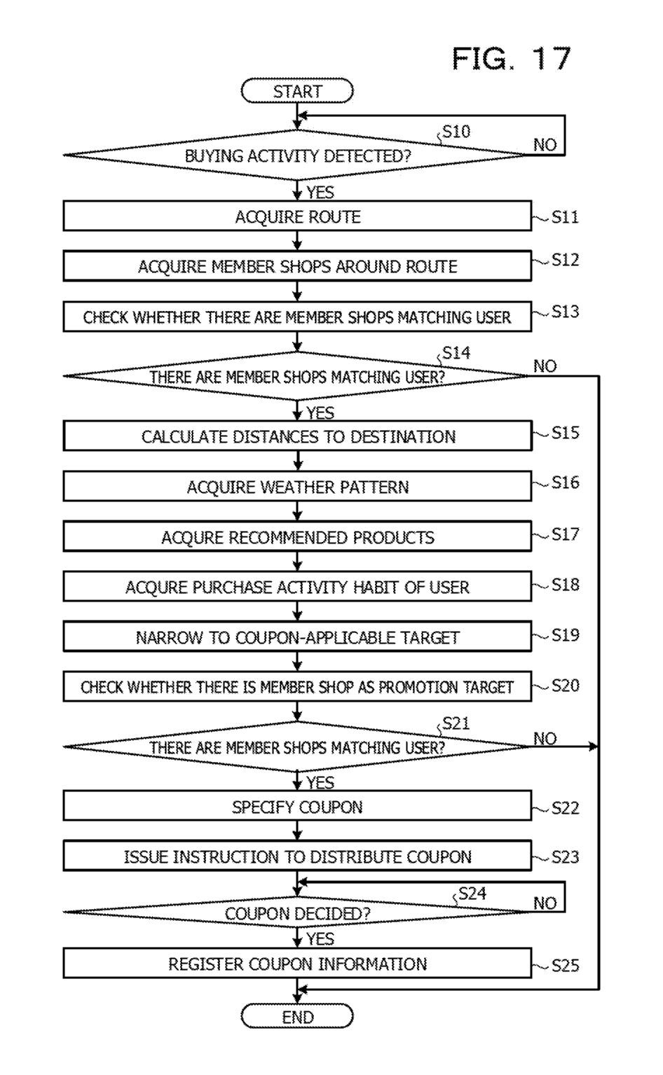

Next, a flow of the coupon distribution processing according to this Example is described. FIG. 17 is a flowchart that illustrates an exemplary procedure of the coupon distribution processing according to Example 1. This coupon distribution processing is executed at a timing at which the buying activity of the user is detected (S10 Yes). The information output device 11 waits without executing the coupon distribution processing until the buying activity of the user is detected (S10 No).

When the distribution condition is satisfied, first, the acquisition section 91 refers to the course information 60 and acquires the current location coordinates, the destination coordinates, and the route of the user (S11). Next, the acquisition section 91 refers to the member shop information 62 and acquires member shops around the acquired route and destination (S12). The acquisition section 91 then refers to the member information 61 and the member shop information 62 and checks whether there are member shops having the target customer type that matches the segment of the user (S13).

Here, when there are member shops having the target customer type matching the segment of the user (S14 Yes), the calculation section 92 calculates the distance between each of these member shops and the destination and stores resulting distances in the storage unit 16 as the distance information 95 (S15). Next, the acquisition section 91 refers to the weather information 63 and acquires the weather pattern at the current location of the user (S16). The acquisition section 91 then refers to the weather-dependent recommended product information 64 and, according to the acquired weather pattern, acquires recommended products of the member shops having the target customer type that matches the segment of the user (S17). The acquisition section 91 then refers to the purchase activity information 65 and acquires products of which purchase frequency by the user is high in each type of the member shops (S18). It is noted that, when there is no member shop having the target customer type that matches the segment of the user (S14 No), the information output device 11 ends the processing.

Based on the acquired recommended products and the products of which purchase frequency by the user is high, the acquisition section 91 narrows the products to the coupon-applicable target (S19). The acquisition section 91 then refers to the promotion information 82 and checks whether there is a member shop as the promotion target, that is, a member shop holding a product for which the automatic promotion implementation flag is ON (S20).

When there is a member shop as the promotion target (S21 Yes), the specification section 93 specifies a coupon to be distributed. For example, out of the member shops having the target customer type that matches the segment of the user, the specification section 93 specifies, as the coupon-provider member shop, the member shop located around the route and closer to the destination than the other member shop in which the buying activity of the user has been detected. Meanwhile, out of the member shops having the target customer type that matches the segment of the user, the specification section 93 specifies, as the coupon-use member shop, the member shop located around the route and closer to the destination than the other member shop in which the buying activity of the user has been detected, and the specification section 93 specifies, as the coupon-applicable target product, the product narrowed to the coupon-applicable target by the acquisition section 91 (S22). It is note that, when there is no promotion target member shop (S21 No), the information output device 11 ends the processing.

The distribution section 94 distributes the coupon specified by the specification section 93 to the user terminal 20 (S23). Then, when the user decides a desired coupon out of the distributed coupons (S24 Yes), the information on that coupon decided by the user is registered in the coupon distribution information 67 (S25). It is noted that, when no coupon is decided by the user (S24 No), the information output device 11 waits until a coupon is decided.

It is noted that the processing for specifying the coupon content, coupon-provider member shop, and coupon-use member shop is not limited to S16 to S21. For example, a member shop randomly selected from the member shops located around the route and closer to the destination than the member shop in which the buying activity of the user has been detected may be the coupon-use member shop and the coupon-provider member shop.

S24 or S25 is not necessarily performed. In this case, the information output device 11 distributes the coupons, and the distributed coupons may be managed by another device or system.

The information output device 11 according to this Example detects that the buying activity in the first shop or the first facility is performed by the user. The information output device 11 acquires information from the storage unit that stores the shop information or the facility information and the location information such that the shop information or the facility information is associated with the location information. The information output device 11 specifies the second shop or the second facility. The second shop or the second facility is in the predetermined positional relationship with the route information which is the result of search to the destination for which the setting has been received from the user terminal used by the user. Also, the second shop or the second facility is located closer to the destination than the first shop or the first facility.

The information output device 11 causes the terminal provided in the first shop or the first facility to output the receipt including the information on the payment details as a result of the buying activity and the information for introducing the second shop or the second facility. Furthermore, the information output device 11 generates the message including the information indicating the payment details as a result of the buying activity in the first shop or the first facility and the information introducing the second shop or the second facility and transmits the generated message to the user terminal. This may provide the arrangement that allows the plurality of shops to cooperate with one another so as to encourage the user to come to their shops.

It is noted that, in order to achieve the above-described effect using the information output device 11 according to this Example, the matching system 10 does not necessarily have all the elements illustrated in FIG. 1. For example, it is sufficient that the matching system 10 have at least the information output device 11, the course information 60, and the member shop information 62.

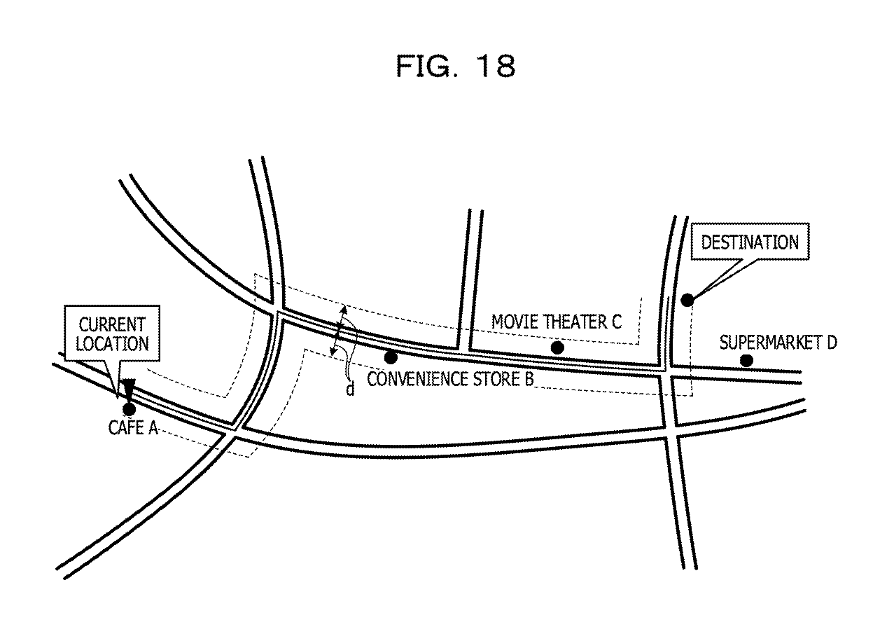

FIG. 18 is a diagram for describing matching according to Example 1. In the example of FIG. 18, the acquisition section 91 determines a region within a distance d from a certain point on the route as around the route. In this case, for example, the acquisition section 91 acquires the cafe A, the convenience store B, and the movie theater C as the member shops around the route.

For example, the convenience store B is located on the route and closer to the destination than the cafe A. Thus, according to this Example, the information introducing the convenience store B may be provided to the user performing the buying activity in the cafe A. This may encourage the user to use the convenience store B.

Furthermore, the user may focus attention on the shop information on each of the shops more when the information is separately transmitted on a shop-by-shop basis than when the information on a plurality of the shops is transmitted to the user at a time. Furthermore, the user visits a single shop at a time. Thus, as is the case with this Example, separately transmitting the information on a shop-by-shop basis when the user easily visits the shop may increase convenience for the user.

### Example 2

Although Example relating to the system disclosed has been described, the disclosed technique may be implemented in various different forms in addition to Example described above. Therefore, another Example included in the embodiments will be described below.

For example, according to Example described above, the example is described in which, when the user performs the buying activity in the first shop or the first facility, the information introducing the second shop or the second facility is provided. However, the disclosed system is not limited to this. For example, it is thought that the information output device 11 provides information on a third shop or a third facility when the user performs the buying activity in the second shop or the second facility.

After the receipt including the information introducing the second shop or the second facility has been output, or after the message including the information introducing the second shop or the second facility has been transmitted, the detection section 90 further detects that the buying activity is performed by the user in the second shop or the second facility. The acquisition section 91 acquires information from the storage unit that stores the shop information or the facility information and the location information such that the shop information or the facility information is associated with the location information.

The specification section 93 refers to the information obtained by the acquisition section 91, the information being information in which the shop information or the facility information is associated with the location information. The specification section 93 specifies the third shop or the third facility. The third shop or the third facility is in a predetermined positional relationship with the route information which is a search result to the destination for which the setting has been received from the user terminal used by the user. Also, the third shop or the third facility is located closer to the destination than the second shop or the second facility.

The distribution section 94 causes a terminal provided in the second shop or the second facility to output a receipt including the information on the payment details as a result of the buying activity and the privilege information of the third shop or the third facility. The distribution section 94 generates a message including the information indicating the payment details as a result of the buying activity in the second shop or the second facility and the privilege information of the third shop or the third facility and transmits the generated message to the user terminal.

This may provide the arrangement that allows the plurality of shops to cooperate with one another so as to encourage the user to come to their shops even when there are three or more shops. Furthermore, since the distances between the target shops for the introduction and the destination are reducing, the user may be more efficiently encouraged to come to their shops.

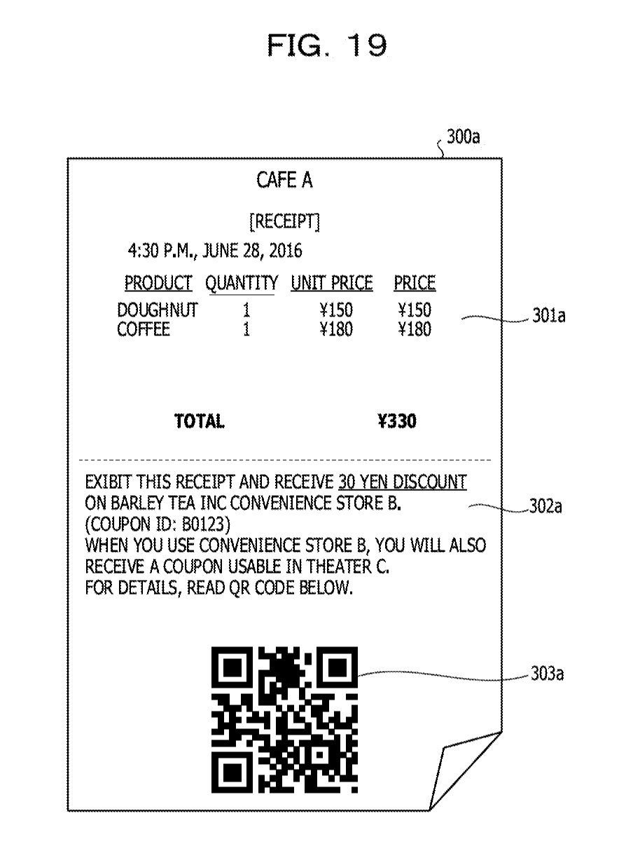

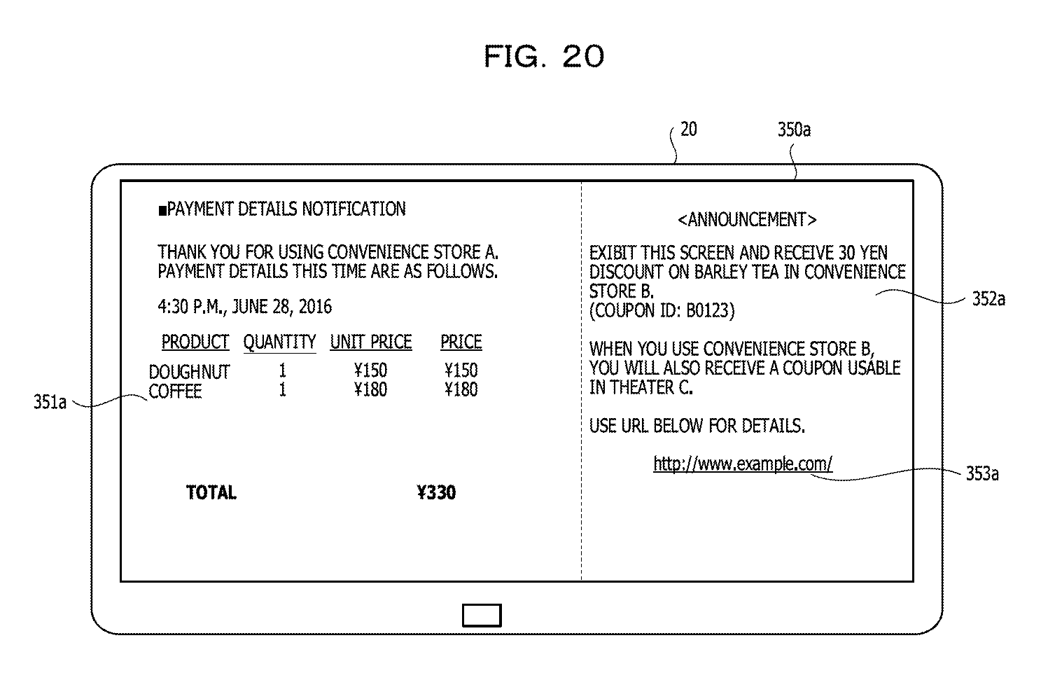

In this case, as illustrated in FIGS. 19 and 20, a message that encourages use of the third shop or the third facility may be presented in advance when the information introducing the second shop or the second facility is provided.

FIG. 19 is a diagram that illustrates an exemplary receipt according to Example 2. As illustrated in FIG. 19, the message that encourages use of the third shop or the third facility is presented together with the information introducing the second shop or the second facility in a promotion region 302a of a receipt 300a. In the example of FIG. 19, a message presenting that, by using the convenience store B, a coupon usable in the movie theater C is also provided is presented in the promotion region 302a.

A sales information presenting region 301a presents therein information on the name, the quantity, the unit price, and the price of the sold product, the information being exemplary information indicative of the payment details as a result of the purchase activity. A link presenting region 303a presents the QR code indicative of the URL of the website on which the details of the second shop or the second facility are published.

FIG. 20 is a diagram that illustrates an exemplary payment details notification screen according to Example 2. As illustrated in FIG. 20, the message that encourages use of the third shop or the third facility is displayed together with the information introducing the second shop or the second facility in a promotion region 352a of a payment details notification screen 350a. In the example of FIG. 20, the message indicating that, by using the convenience store B, a coupon usable in the movie theater C is also provided is displayed in the promotion region 352a.

A payment information display region 351a displays therein information on the name, the quantity, the unit price, and the price of the sold product, the information being exemplary information indicating the payment details as a result of the purchase activity. A link display region 353a displays the URL of the website on which the details of the second shop or the second facility are published.

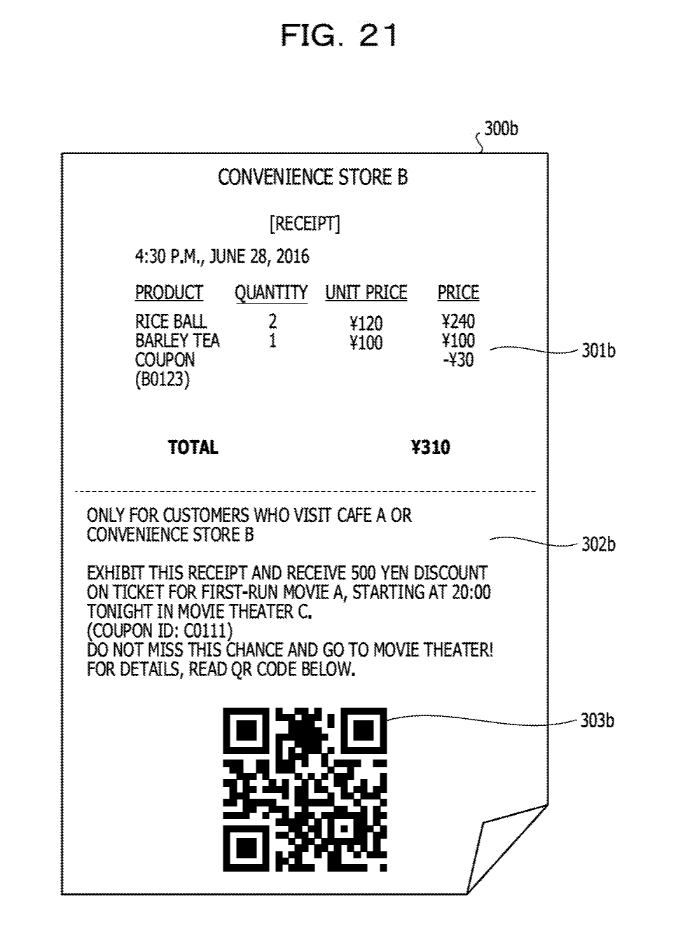

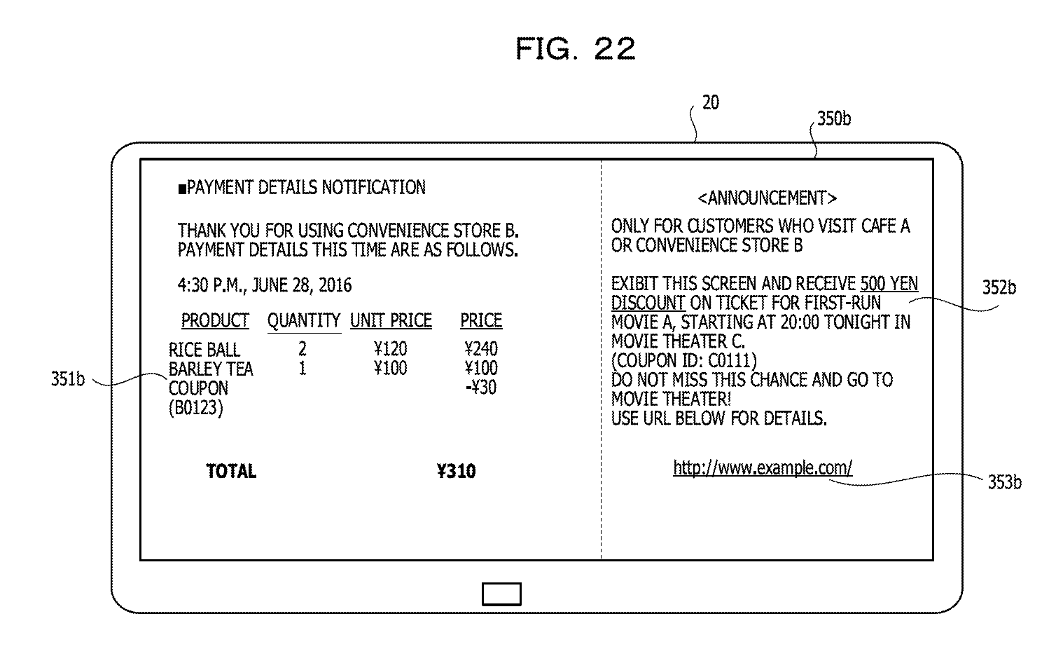

Furthermore, when the user having performed the buying activity in the second shop or the second facility also performs the buying activity in the third shop or the third facility, this user may be provided with the privilege information. In this case, as illustrated in FIGS. 21 and 22, when the information introducing the second shop or the second facility is provided, a message saying that, by also using the third shop or the third facility, the privilege information is provided may be presented.

FIG. 21 is a diagram that illustrates an exemplary receipt according to Example 2. As illustrated in FIG. 21, the message saying that, by also using the third shop or the third facility, the privilege information is provided is presented together with the information introducing the second shop or the second facility in a promotion region 302b of a receipt 300b. In the example of FIG. 21, the message indicating that, by also using the convenience store B, a coupon usable in the movie theater C is also provided is presented in the promotion region 302B.

A sales information presenting region 301b presents therein the information on the name, the quantity, the unit price, and the price of the sold product, the information being exemplary information indicative of the payment details as a result of the purchase activity. A link presenting region 303b presents the QR code indicating the URL of the website on which the details of the second shop or the second facility are published.

FIG. 22 is a diagram that illustrates an exemplary payment details notification screen according to Example 2. As illustrated in FIG. 22, the message saying that, by also using the third shop or the third facility, the privilege information is provided is displayed together with the information introducing the second shop or the second facility in a promotion region 352b of a payment details notification screen 350b. In the example of FIG. 22, the message indicating that, by using the convenience store B, a coupon usable in the movie theater C is also provided is displayed in the promotion region 352a.

A payment information display region 351b displays therein the information on the name, the quantity, the unit price, and the price of the sold product, the information being exemplary information indicating the payment details as a result of the purchase activity. A link display region 353b displays the URL of the website on which the details of the second shop or the second facility are published.

For example, the user terminal 20 may be provided with an application for receiving the route search service from the navigation server 40, an application for receiving the weather information provision service from the weather information server 41, and an application for receiving the payment service from the payment application server 42.

Meanwhile, the user terminal 20 may be provided with a single application for receiving all of the route search service from the navigation server 40, the weather information provision service from the weather information server 41, and the payment service from the payment application server 42.

For example, the information output device 11 may estimate a transportation device of the user based on moving speed of the user terminal 20 acquired from the user terminal 20 and, based on the estimated transportation device, properly change the criterion for determining whether the member shop is around the route. For example, when the moving speed of the user terminal 20 is equal to or below 4 km/h, the information output device 11 determines that the user is moving on foot and determines within 500 m from the route as around the route. In contrast, when the moving speed of the user terminal 20 is more than 4 km/h, the information output device 11 determines that the user is moved by an automobile and determines within 1 km from the route as around the route. In this way, it is possible to provide the user with information on a member shop that the user easily uses.

The member shop may be categorized in a plurality of groups. At this time, the information output device 11 provides the user with information introducing a member shop that belongs to a group to which a member shop in which the buying activity of the user has been detected also belongs and is located near the route of the user.

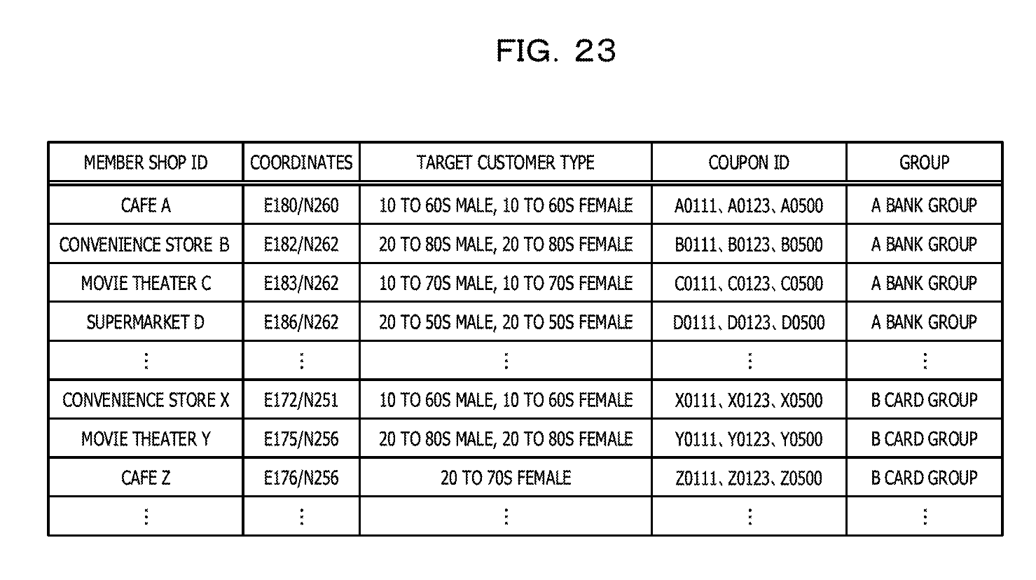

FIG. 23 is a diagram that illustrates an exemplary data configuration of the member shop information including the group. In the example of FIG. 23, the member shop is categorized into A bank group and B card group. The group categorization may be, for example, categorizing member shops receiving loans from the same bank into the same group, categorizing member shops in which the same credit card is usable into the same group, categorizing member shops in which a common point card service is introduced into the same group, and the like.

In this case, the information output device 11 specifies the second shop from member shops belonging to the same group as the first shop. Thus, since the combined information which is obtained by combining information on the member shops in the same group is distributed to the user, this may not only improve the convenience for the user but also increase the benefit of the entire group by allowing the member shops to cooperate with one another. A desirable arrangement which reflects not only the convenience for the user but also, naturally, a circumstance of the facility side when distributing the information on the shop may be provided. In addition, as for the circumstance of the facility side, a desirable arrangement is able to reflect not only a circumstance of a single facility but also an entire circumstance when a plurality of facilities are rendered as a group. Specifying the second shop from the member shops belonging to the same group as the first shop makes it possible to execute shop information distribution processing to the user that reflects the entire circumstance when a plurality of facilities are rendered as a group.

The matching system 10 may be a single device or may include a plurality of devices. For example, the matching system 10 may be implemented as a single device that has functions of the information output device 11, the storage device 12, and the service provision device 13. The matching system 10 may have a single server device that has all functions of the APIs 50 to 54.

In addition, the respective elements of each of the devices illustrated in the drawings are functionally conceptual and are not necessarily physically configured as illustrated. For example, a concrete state of each device such as being separated or integrated are not limited to the illustration, and all or a part of the device may be constructed by being functionally or physically separated or integrated in an arbitrary unit according to various loads and use states. For example, the respective processing sections of the acquisition section 91, the specification section 93, and the distribution section 94 of the information output device 11 may be properly integrated or separated. In addition, all or arbitrary part of each processing function performed in each processing section may be realized by a CPU and a program analyzed and executed by the CPU or may be realized as hardware by a wired logic.

### Information Output Program

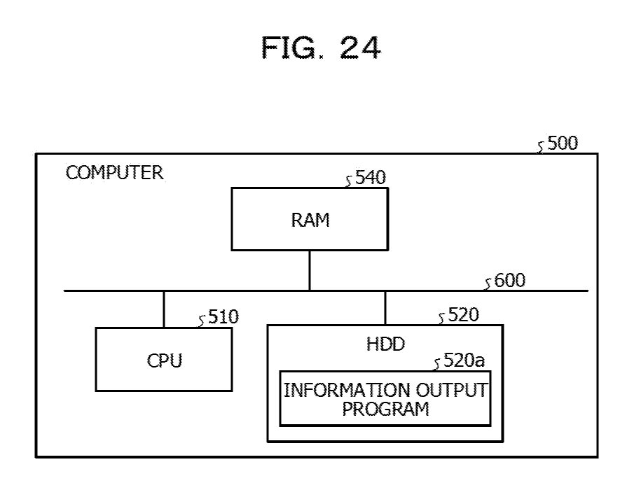

In addition, various types of the processing described in above Examples may also be realized by executing a prepared program on a computer system such as a personal computer or a workstation. Therefore, in the following, an example of a computer system that executes a program having similar functions as those of above Examples will be described. FIG. 24 is a diagram that illustrates a computer that executes an information output program.

As illustrated in FIG. 24, a computer 500 has a CPU 510, a hard disk drive (HDD) 520, and a RAM 540. These units 510 to 540 are coupled to each other via a bus 600.

The HDD 520 stores in advance an information output program 520a that functions similarly to the processing sections of above Examples. For example, the HDD 520 stores the information output program 520a that functions similarly to the information output device 11 of above Examples. It is noted that the information output program 520a may be properly separated.

The HDD 520 stores various types of data. For example, the HDD 520 stores an OS and various types of data.

The CPU 510 executes the operations similar to those of the respective processing sections of Examples by reading the information output program 520a from the HDD 520 and executing the information output program 520a. For example, the information output program 520a executes the operations similar to those of the information output device 11 of Examples.

It is noted that the above-described information output program 520a are not necessarily initially stored in the HDD 520. For example, the program may be stored in a “portable physical medium” to be inserted into the computer 500 such as a flexible disk (FD), a compact disk read-only memory (CD-ROM), a digital versatile disk (DVD), a magnetooptical disk, or an IC card. The computer 500 then may execute the program by reading the program from the medium.

Otherwise, the program may be stored in “another computer (or server)” or the like coupled to the computer 500 via a public network, the Internet, a LAN, a wide area network (WAN), or the like. The computer 500 then may execute the program by reading the program from the other computer or server.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recording an information output program for causing a computer to execute a process, the process comprising:
detecting that a user performs first buying in a first shop or a first facility;
referring to memory in which shop information or facility information and location information are stored in association with each other;
specifying one or more second shops or one or more second facilities that is in a predetermined positional relationship with route information which is a result of a search to a destination received from a user terminal used by the user and that is located closer to the destination than the first shop or the first facility;
generating a first message that includes information indicative of a payment detail as a result of the first buying and information introducing the one or more second shops or the one or more second facilities; and
outputting the first message as a receipt to a terminal provided in the first shop or the first facility or transmitting the first message to the user terminal.

2. The non-transitory computer-readable recording medium according to claim 1,
wherein the process further includes:
detecting that second buying is performed by the user in the one or more second shops or the one or more second facilities after the outputting of the first message as the receipt or the transmitting of the first message,
referring to the memory,
specifying a third shop or a third facility that is in the predetermined positional relationship with the route information and that is located closer to the destination than the one or more second shops or the one or more second facilities,
generating a second message that includes information indicative of a payment detail as a result of the second buying and privilege information usable in the third shop or the third facility, and
outputting the second message as a receipt to a terminal provided in the one or more second shops or the one or more second facilities or transmitting the second message to the user terminal.

3. The non-transitory computer-readable recording medium according to claim 1,
wherein the process further includes:
acquiring user information on an attribute of the user, and
writing in the first message a shop or a facility that matches the user information out of the one or more second shops or the one or more second facilities having been specified.

4. The non-transitory computer-readable recording medium according to claim 1,
wherein the information introducing the one or more second shops or the one or more second facilities includes privilege information usable in the one or more second shops or the one or more second facilities.

5. The non-transitory computer-readable recording medium according to claim 4,
wherein the privilege information usable in the one or more second shops or the one or more second facilities is generated based on a weather pattern.

6. An information output method comprising:
detecting, by a computer, that a user performs first buying in a first shop or a first facility;
referring to memory in which shop information or facility information and location information are stored in association with each other;
specifying one or more second shops or one or more second facilities that is in a predetermined positional relationship with route information which is a result of a search to a destination received from a user terminal used by the user and that is located closer to the destination than the first shop or the first facility;
generating a first message that includes information indicative of a payment detail as a result of the first buying and information introducing the one or more second shops or the one or more second facilities; and
outputting the first message as a receipt to a terminal provided in the first shop or the first facility or transmitting the first message to the user terminal.

7. The information output method according to claim 6, further comprising:
detecting that second buying is performed by the user in the one or more second shops or the one or more second facilities after the outputting of the first message as the receipt or the transmitting of the first message;
referring to the memory;
specifying a third shop or a third facility that is in the predetermined positional relationship with the route information and that is located closer to the destination than the one or more second shops or the one or more second facilities;
generating a second message that includes information indicative of a payment detail as a result of the second buying and privilege information usable in the third shop or the third facility; and
outputting the second message as a receipt to a terminal provided in the one or more second shops or the one or more second facilities or transmitting the second message to the user terminal.

8. The information output method according to claim 6, further comprising:
acquiring user information on an attribute of the user; and
writing in the first message a shop or a facility that matches the user information out of the one or more second shops or the one or more second facilities having been specified.

9. The information output method according to claim 6,
wherein the information introducing the one or more second shops or the one or more second facilities includes privilege information usable in the one or more second shops or the one or more second facilities.

10. The information output method according to claim 9,
wherein the privilege information usable in the one or more second shops or the one or more second facilities is generated based on a weather pattern.

11. An information processing apparatus comprising:
a memory; and
a processor coupled to the memory and configured to:
detect that a user performs first buying in a first shop or a first facility;
refer to memory in which shop information or facility information and location information are stored in association with each other;
specify one or more second shops or one or more second facilities that is in a predetermined positional relationship with route information which is a result of a search to a destination received from a user terminal used by the user and that is located closer to the destination than the first shop or the first facility;
generate a first message that includes information indicative of a payment detail as a result of the first buying and information introducing the one or more second shops or the one or more second facilities; and
output the first message as a receipt to a terminal provided in the first shop or the first facility or transmitting the first message to the user terminal.

12. The information processing apparatus according to claim 11,
wherein the processor is configured to:
detect that second buying is performed by the user in the one or more second shops or the one or more second facilities after the outputting of the first message as the receipt or the transmitting of the first message;
refer to the memory;
specify a third shop or a third facility that is in the predetermined positional relationship with the route information and that is located closer to the destination than the one or more second shops or the one or more second facilities;
generate a second message that includes information indicative of a payment detail as a result of the second buying and privilege information usable in the third shop or the third facility; and
output the second message as a receipt to a terminal provided in the one or more second shops or the one or more second facilities or transmitting the second message to the user terminal.

13. The information processing apparatus according to claim 11,
wherein the processor is configured to:
acquire user information on an attribute of the user; and
write in the first message a shop or a facility that matches the user information out of the one or more second shops or the one or more second facilities having been specified.

14. The information processing apparatus according to claim 11,
wherein the information introducing the one or more second shops or the one or more second facilities includes privilege information usable in the one or more second shops or the one or more second facilities.

15. The information processing apparatus according to claim 14,
wherein the privilege information usable in the one or more second shops or the one or more second facilities is generated based on a weather pattern.
